(19) United States
(12) Patent Application Publication
(10) Pub. No.: US 2016/0350839 A1
(43) Pub. Date: Dec. 1, 2016

(54) INTERACTIVE ORDERING OF MULTIVARIATE OBJECTS

(71) Applicant: Twiggle Ltd., Tel-Aviv (IL)

(72) Inventors: Adi AVIDOR, Tel-Aviv (IL); Omri SHACHAM, Tel-Aviv (IL); Amir KONIGSBERG, Tel-Aviv (IL)

(21) Appl. No.: 14/720,860

(22) Filed: May 25, 2015

(51) Int. Cl. G06Q 30/06

(52) U.S. Cl. CPC G06Q 30/0641

(57) ABSTRACT

A method of iteratively adapting an order of multivariate objects. The method comprises instructing a presentation of a plurality of entries representing a plurality of multivariate objects in an order set according to at least one of a plurality of object variants on a display and iteratively updating the order in a plurality of iterations wherein in each one of the plurality of iterations: identifying a user selection indicative of a new object variant from the plurality of object variants, calculating a new order for the a plurality of multivariate objects by a ordering function combining the new object variant and the at least one object variant, and instructing an update for the presentation, wherein the update replaces the order with the new order.

### BACKGROUND

The present invention, in some embodiments thereof, relates to data presentation and, more specifically, but not exclusively, to iterative data presentation that is adapted to according to user inputs.

Product and service searches are currently used to search for products or services on a computer network, such as the Internet. Typically a user inputs search criteria, such as a phrase, a word, a combination of words, etc. into a search engine or selects one or more categories or sub categories. Searches may be conducted using a natural language style, a Boolean logic style, a pre-prepared search form, and the like. Searches using a search engine typically produce search results in the form of a results list that include a large number of entries. Often a user may look at only few search results which appear first. Valuable entries in the results list may be missed by a user because the entries are scattered among a large number of entries in the results list. Moreover, the ranking (or sorting) of results is widely recognized as being an important factor determining the usefulness of results.

### SUMMARY

According to some embodiments of the present invention there is provided a method of iteratively adapting an order of multivariate objects, comprising: instructing a presentation of a plurality of entries representing a plurality of multivariate objects in an order set according to at least one of a plurality of object variants on a display, and iteratively updating the order in a plurality of iterations wherein in each one of the plurality of iterations: identifying a user selection indicative of a new object variant from the plurality of object variants, calculating a new order for the plurality of multivariate objects by an ordering function combining the new object variant and the at least one object variant, and instructing an update for the presentation, wherein the update replaces the order with the new order.

Optionally, each one of the plurality of object variants is associated with a weight; wherein the ordering function takes into account respective the weight of the new object variant and of the at least one object variant.

Optionally, the user selection comprises selecting whether the new object variant is used as an ascending ordering factor or as a descending ordering factor; wherein the calculating is performed according to the selecting.

Optionally, the method further comprises selecting the plurality of multivariate objects as a response to at least one of a search query and a user category selection.

Optionally, the user selection is a single click or finger tap on one of a plurality of selectable items which are presented on the display to represent the plurality of object variants.

Optionally, in each one of the plurality of iterations the user selection is made using a different control with a plurality of selectable items indicative of the plurality of object variants.

Optionally, in each one of the plurality of iterations the user selection is made using the same control with a plurality of selectable items indicative of the plurality of object variants.

Optionally, the user selection comprises selecting an object variant range for at least one of the new object variant and the at least one object variant.

Optionally, the new object variant is a quantifiable characteristic of a product or a service.

Optionally, the new object variant is quantifiable characteristic of a part of a product or a service.

Optionally, the new object variant is a suitability for a certain demographic segment or proficiency.

Optionally, the new object variant is a level of a functionality or the object of a product or a service.

Optionally, at least some of the plurality of object variants are added to a control receiving the user selection after a match a category to which the plurality of multivariate objects belongs.

Optionally, at least some of the plurality of object variants are added to a control receiving the user selection after a match with a user profile of a user making the user selection.

According to some embodiments of the present invention there is provided a system of iteratively adapting an order of multivariate objects. The system comprises an interface adapted to send to a browser or an application running on a client instructions to render a presentation of a plurality of entries representing a plurality of multivariate objects in an order set according to at least one of a plurality of object variants on a display, at least one processor a memory hosting a code, wherein the code is implementable by the at least one processor for iteratively calculating instructions to update the order in a plurality of iterations wherein in each one of the plurality of iterations the following code instructions are executed: code instructions for identifying a user selection indicative of a new object variant from the plurality of object variants, code instructions for calculating a new order for the plurality of multivariate objects by a ordering function combining the new object variant and the at least one object variant, and code instructions for updating for the presentation by replacing the order with the new order.

According to some embodiments of the present invention there is provided a method of iteratively adapting an order of multivariate objects. The method comprises receiving a search query, identifying a plurality of multivariate objects which comply with the search query, extracting a plurality of object variants from the search query, and calculating an order for the plurality of multivariate objects by an ordering function combining at least one ordering factor defined by at least one of the plurality of object variants with at least one other ordering factor defined by at least one other of the plurality of object variants, and instructing a presentation of at least some of the plurality of multivariate objects in the order.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of iteratively adapting an order of multivariate objects according to a plurality of object variants which are iteratively added according to user selections, according to some embodiments of the present invention;

FIGS. 2A and 2B are schematic illustrations of system for implementing a method of iteratively adapting an order of multivariate objects, for example as depicted in FIG. 1, according to some embodiments of the present invention;

FIG. 3A is an exemplary control having a combo box with a plurality of selectable items which are automatically added in response to a user selection, according to some embodiments of the present invention;

FIG. 3B is a schematic illustration of an exemplary control having a combo box and an add button that allows a user to add an additional combo box such that each one of the object variants is added by a different combo box, according to some embodiments of the present invention;

FIG. 3C is a schematic illustration of an exemplary control having three combo boxes for selecting object variants, according to some embodiments of the present invention;

FIG. 4 is an exemplary screenshot of an exemplary GUI having a plurality of scales for allowing a user to adapt the range of object variants, according to some embodiments of the present invention;

FIG. 5 is a schematic illustration of an exemplary control that allows a user to select, by a single user input, a combination of object variables for ordering multivariate objects, according to some embodiments of the present invention;

FIG. 6A is a schematic illustration of a combo box that includes selectable items, each associates a sorting order with an object variant, according to some embodiments of the present invention;

FIG. 6B is a schematic illustration of an exemplary set of virtual buttons, each associates a sorting order with an object variant, according to some embodiments of the present invention; and

FIG. 7 is a flowchart of a method of adapting an order of multivariate objects according to a plurality of object variants extracted from a search query, according to some embodiments of the present invention.

### DETAILED DESCRIPTION

The present invention, in some embodiments thereof, relates to data presentation and, more specifically, but not exclusively, to iterative data presentation that is adapted to according to user inputs and/or search query terms.

According to some embodiments of the present invention, there are provided methods and systems for iteratively updating an order of entries representing multivariate objects (entries and multivariate objects may be referred to intermittently) based on a combination of two or more ordering factors, such as quantifiable object variants which are referred to herein as object variants. In use, the object variants which are used for ordering are selected by the user, for example using a graphical user interface that is presented to the user. The graphical user interface includes a control with a plurality of selectable items, for example a combo box and the selection of one of the plurality of selectable items, for instance by a single click, tap, a gesture, and/or an item selected based on a sensor reading, for instance item selected based on location data, inventory sensor, temperature sensor and/pr the like is used for adding an object variant to an ordering function combining the currently selected object variant with previously added or selected object variant(s) from the plurality of optional object variants.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

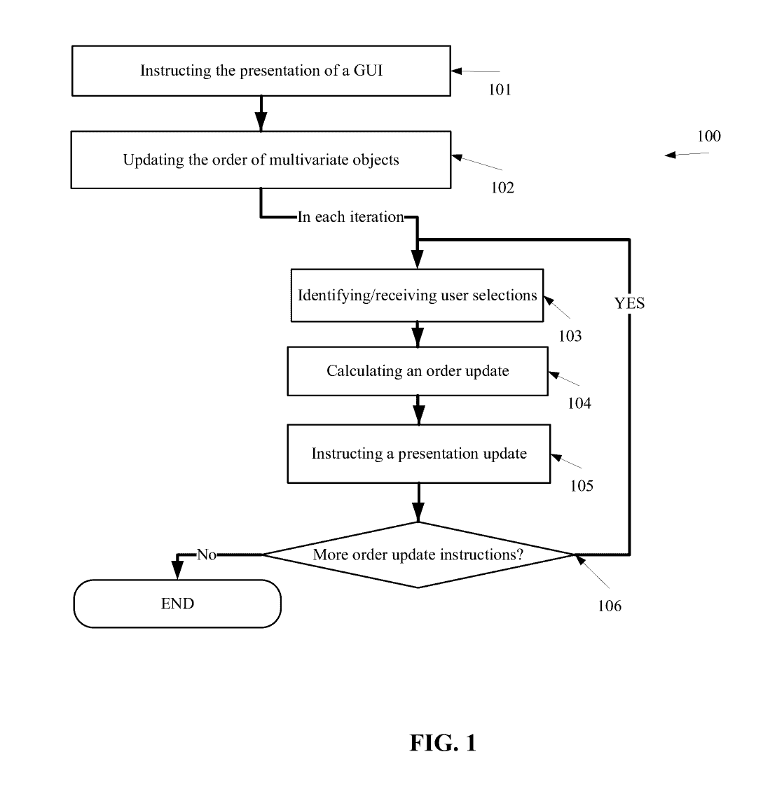

Reference is now made to FIG. 1 which is a flowchart 100 of a method of iteratively adapting an order of multivariate objects according to a plurality of object variants which are iteratively added according to user selections, according to some embodiments of the present invention. The method allows a user to update and order multiple multivariate objects which comply with a product and/or service definition, for example retrieved in response to a search query, a product or service category selection, and/or the like. During the process the user dynamically determines how the multivariate objects are arranged. Object variants such as price, release date, popularity, weight, height, width, score, and/or quality are combined to define a single user preferred order.

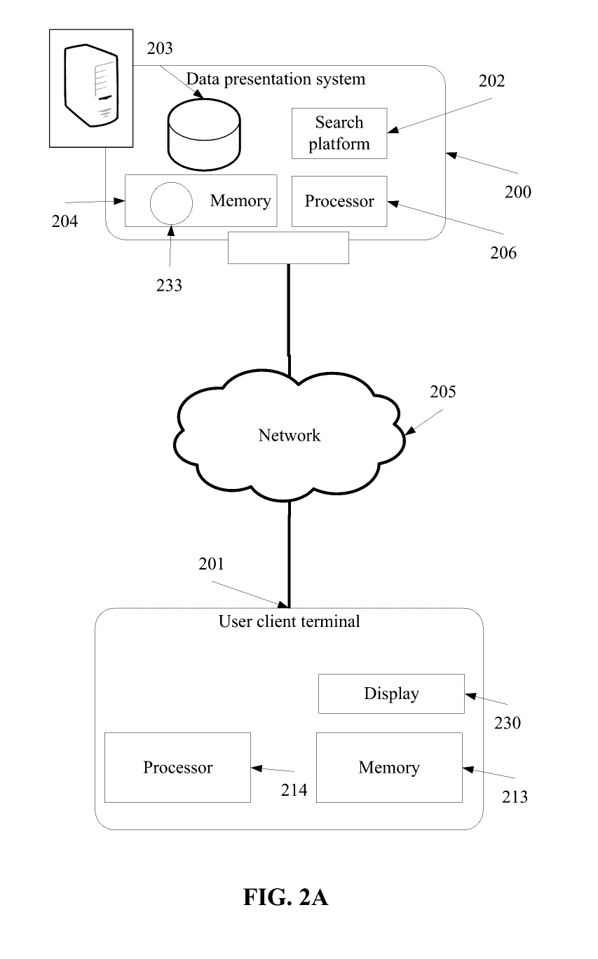

Reference is also made to FIG. 2A which is a schematic illustration of system 200 for implementing a method of iteratively adapting an order of multivariate objects, for example as depicted in FIG. 1, according to some embodiments of the present invention. The schematic illustration depicts the system and a client terminal 201 rendering a graphical user interface (GUI) that is used for receiving, from a human user, object variants and/or object variant ranges, according to some embodiments of the present invention. The data presentation system 200 may be implemented by one or more network nodes which are connected to a network 205 such as the internet, for example one or more servers, virtual machines (VM) and/or the like. The GUI is optionally an interactive user interface rendered or otherwise displayed on a screen 230 of the client terminal, for instance by a browser executed on the client terminal. The client terminal 201 includes processor(s) 214 and a memory unit 213 for supporting the presentation of the GUI, for example by executing a browser, an add-on, and/or an application loading and rendering the GUI and identifies the user selections. The GUI includes one or more selection controls that allow a user to input object variants and/or object variant ranges, for example one or more combo boxes with object variants and/or object variant ranges as selectable items, one or more scales each defining a range of another object variant, text field(s), selectable icon(s), selectable images, interactive graphical object(s) and/or any control that allows a user to select or define an object variant by one or more button presses, clicks, finger taps and/or gestures. In exemplary embodiments, an object variant is selected by a single user selection, such as a single press of a button, a single gesture, a single finger tap and/or the like. For instance, a user may be presented with a plurality of selectable items, each indicative of another object variant and iteratively add each of a plurality of optional object variants by a click or a tap on one of the selectable items. In one example, multiple object variants are aggregated and represented by a single item, for example a combination of the object variants “Screen Diagonal”, “number of Pixels per inch”, and “Screen type” is represented by a single object variant titled “Display”. In such embodiments, a value of this single object variant for each multivariate object is calculated by an equation taking the values of “Screen Diagonal”, “number of Pixels per inch”, and “Screen type” into account, optionally together with respective weights. This single object variant may be added to other object variants (e.g. regular or combination of object variants) or to more granular variables, to form the designated function.

The data presentation system 200 includes one or more processors 206 and a memory 204 for storing instructions for implementing a data presentation process and an ordering process during which a user iteratively orders multivariate objects, for instance as depicted in FIG. 1. The instructions for implementing a data presentation process and/or the ordering process, referred to herein as an ordering module 231, may be divided between a number of units, for example different servers of the system 200 and/or between the system 200 and the client terminal 201. The system 200 may include or be connected to a search platform 202, for example a search service of a website or a webpage. The system 200 may include or be connected to one or more databases 203 which store data, for example records or links, related to multivariate objects and values of the object variants. For example, a record may be stored as defined in U.S. Utility patent application Ser. No. 14/681,194 Filed on Apr. 8, 2015, which is incorporated herein by reference. According to some embodiments of the present invention, for example as depicted in FIG. 2B, the ordering module 231 is executed by the user client terminal 201. In such embodiment the multivariate objects or indications thereof are forwarded to the client terminal for ordering by the ordering module 231. In such a manner, latency of the reordering the multivariate objects is eliminated. The ordering module 231 may be a code or a script that is loaded with a webpage, such as a search engine webpage or a shopping webpage of a shopping website and/or a code running by an application installed at the client terminal. The application may be downloaded from an application store or temporarily installed as a widget in an accessed webpage.

In some embodiments, the system is used as a search platform for one or more databases of multivariate objects, such as databases of shopping websites and/or platforms. In such embodiments, the multivariate objects which are ordered are multivariate objects which comply with a search query and/or part of user selected category and/or sub categories. This allows using the system for ordering search results in a user preferred manner, optionally while defining which object variables to use for the ordering and/or what is the range and/or the weight of each object variables. In such embodiment, each multivariate object may be associated with purchase information and/or link.

The above mentioned system and method allows the user to define an order for multivariate objects which comply with his needs based on a combination of non-binary object variables. As explained below, the user can define an ordering function wherein one object variable contributes to ascending order of the multivariate objects (e.g. ordering such that products with higher screen resolution are ordered before products with a lower screen resolution) and another object variable contributes to descending order of the multivariate objects (e.g. ordering such that products with lower costs are ordered before products with higher costs).

As used herein a client or a client terminal means a user that includes presentation means for presenting the GUI, for example a laptop, a desktop, Smart glasses, a smart watch, a tablet, a wearable device and/or the like. As used herein, a multivariate object is a product or a service which is offered for sale or rent and has more than one object variant. As used herein an object variant is:

a quantifiable characteristic of a product or a service, for example weight, size, and durability,

quantifiable characteristic of a part of the object (for example memory size, screen size, computer processing unit power, computer processing unit type, battery type and/or the like),

suitability for a certain demographic segment or proficiency (e.g. suitability for lawyers, programmers and/or the like), and

a level of a functionality of the object or a component thereof (for example power consumption, battery lifespan, and/or the like).

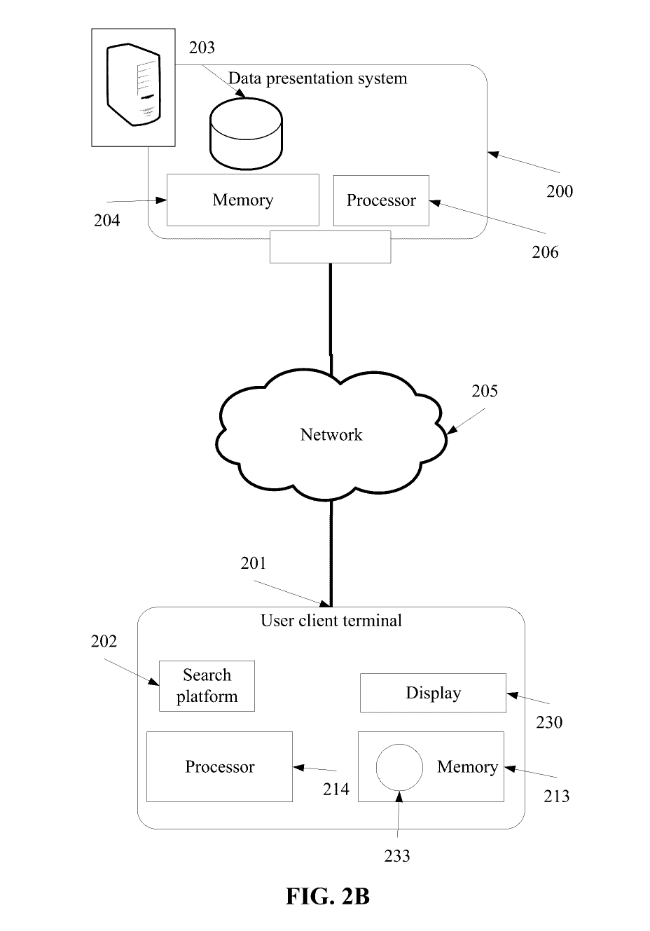

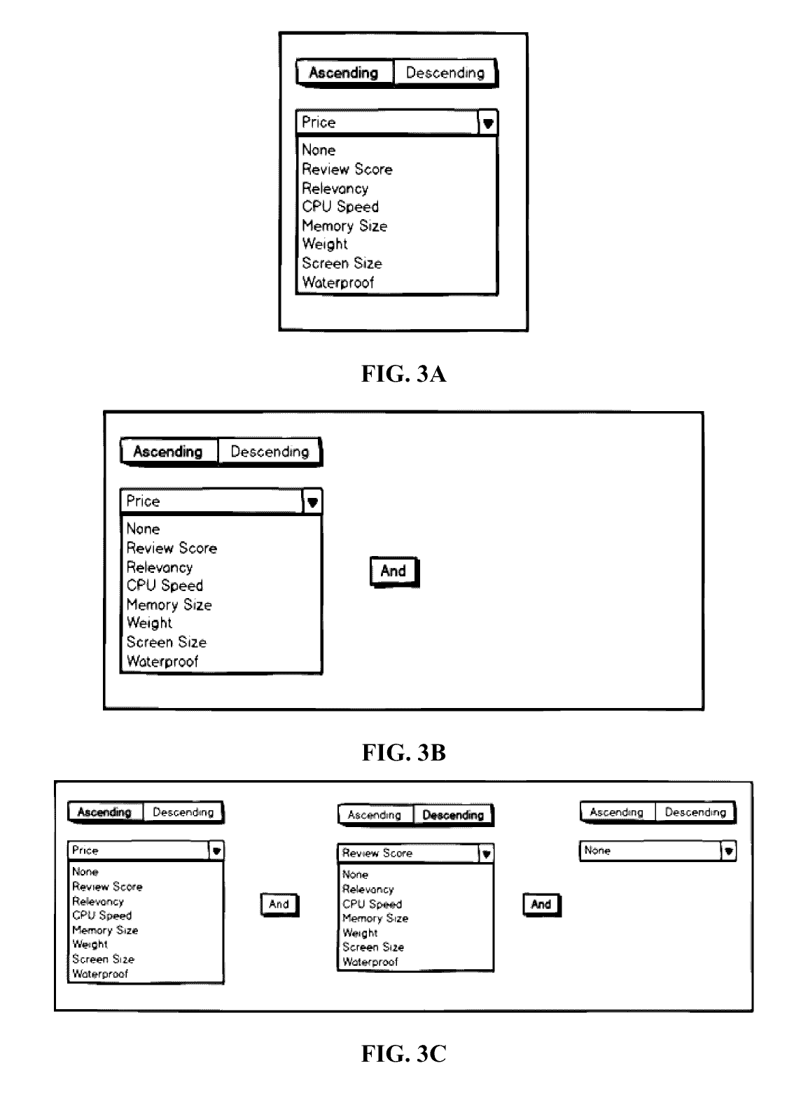

As shown at 101, the system provides the client terminal 201 with instructions to present the GUI. The instructions may be provided to a browser running on the client and/or to an application hosted on and running on the client. For example FIG. 3A depicts an exemplary control 301 having a combo box with a plurality of selectable items which are automatically added in response to a user selection thereof. Optionally, the control further comprises an add button 302 that allows a user to add an additional combo box such that each one of the object variants is added by a different combo box as shown at FIG. 3B. The add button may be a plus sign that leads to the presentation of a dropdown menu as depicted in FIG. 4. Optionally, the add button is presented only after the user made a selection of a variable object in the combo box. Any number of combo boxes may be added, for example see FIG. 3C that depicts 3 combo boxes for selecting 3 object variants.

Optionally, as shown at FIGS. 3A-3C, each combo box or any other control may have an ascending or descending selector 305. This selector allows the user to select whether values of an added object variant should be used an ascending ordering factor or as a descending ordering factor for ordering multivariate objects.

Optionally, the GUI is presented in response to a selection of a multivariate object type, for example a selection of a product type or service type to search for. Exemplary multivariate object types are laptops, cellular devices, home appliances, printers, furniture, flight tickets, hotel rooms, TV sets, portable audio devices, tablets and/or any family of products or services which can be selected by a user input. For example, the GUI is presented as part of a search engine platform for ordering products or services which are related to a selected multivariate object type. In use, after a multivariate object type is selected by the user or automatically of a selection module (e.g. based on a user profile, keyword search and/or browsing history analysis), the GUI is presented for allowing the user to refine and order optional products or services of the selected multivariate object type. The ordering may be done for ordering elements in list(s) or matrix(es) of images.

Optionally, the control has selectable items which represent object variants of a multivariate object from the multivariate object type. In one example, the user selects a product type in an online shop, for example “laptops”. This leads to the presentation of the GUI with a control having selectable items representing object variables of the products from the “laptops” product type. Optionally, selectable items from the Laptop product type are combined with generic selectable items such as popularity, trending, quality, best selling, most reviews, highest rating, and/or the like. Optionally, sorting may be defined by a combination of generic selectable items and Laptop-specific selectable items (e.g., size, weight, CPU).

As shown at 102, the order of the multivariate objects which are presented to the user is updated in a plurality of iterations, for example the multivariate objects which comply with a search query or a product or service definition. The update instructions are optionally calculated by execution of instructions stored in the memory 204 by the system 200. In each one of the iterations, as shown at 103, a user selection inputted by a user who uses the selection control and indicative of one of the object variants is identified or received. For example, the user may select an item in a combo box and/or select object variant from any graphical element that allows selecting one of a plurality of object variants. For instance, as depicted in FIGS. 3A-3C, a user adds a combo box and selects one of a plurality of options in this specific combo box.

Optionally, during each one of the iterations, the user may adapt one or more range(s) of values of one or more of the selected object variants. The adaptation may be done using scales which are presented to the user. Each such adaptation may reduce or increase the number of multivariate objects which are selected for ordering and hence may have an effect on the order itself. For example, see FIG. 4 which is an exemplary screenshot of a GUI having a plurality of scales for allowing a user to adapt the range of object variants such as popularity, architecture, and suitability to lawyers and/or the like.

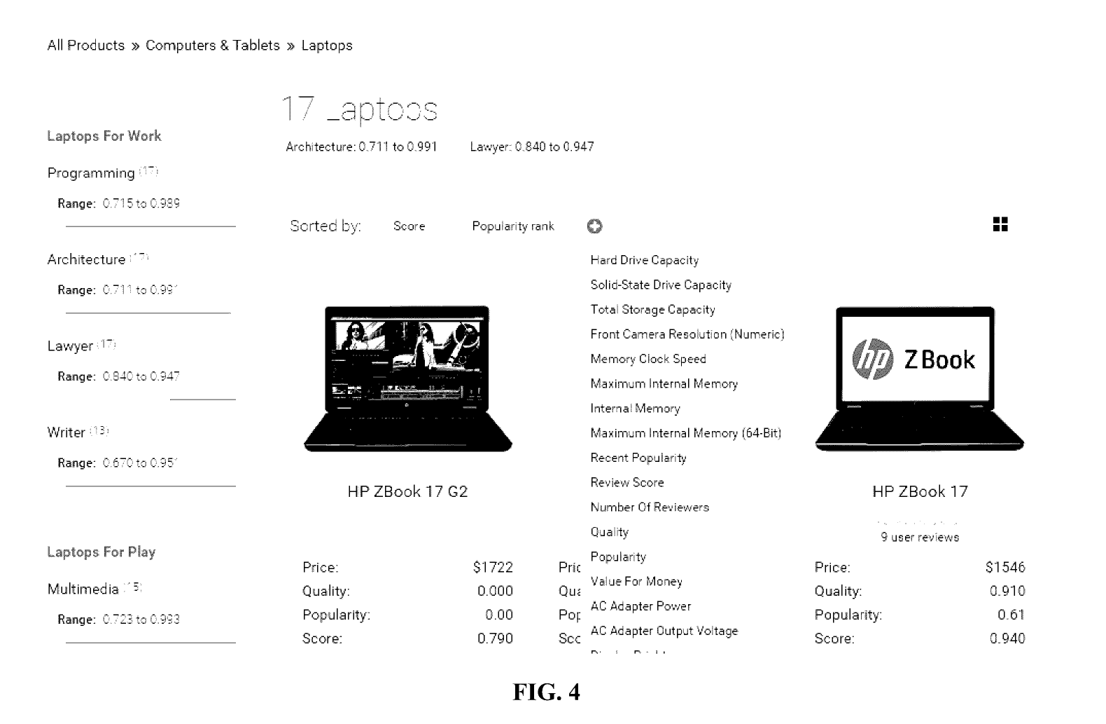

Optionally, the control includes selectable items which allow the user to select, optionally by a single click, finger tap, or gesture, a combination of one or more object variants for ordering. For example, see FIG. 5 which is an exemplary GUI having selectable items which reflect low price and high relevancy are object variants which are selected by a single user input. This allows the use to define preferred factors for ordering.

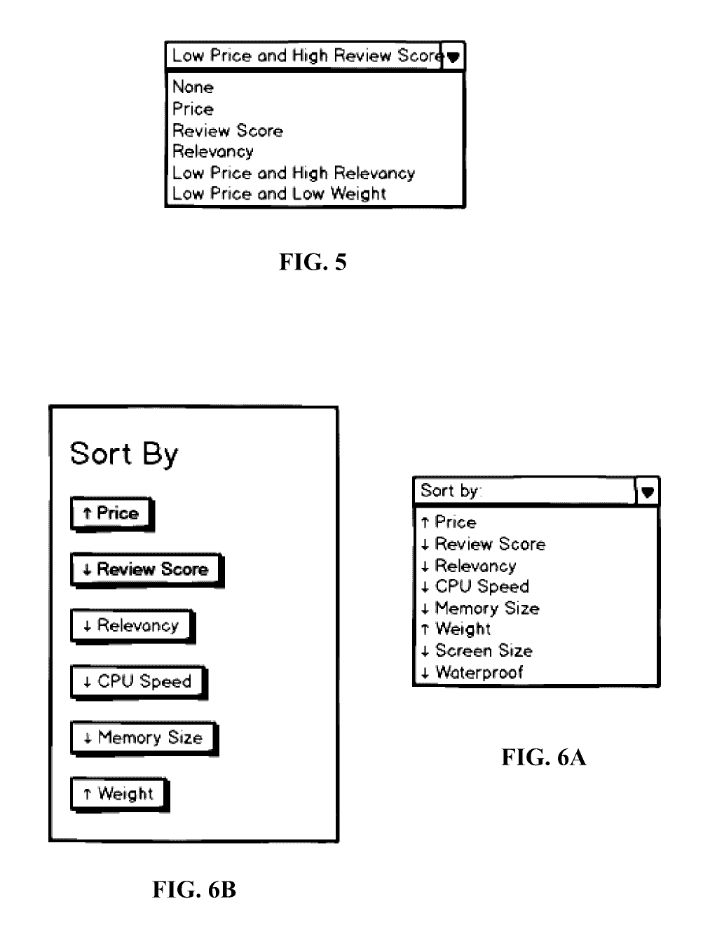

Optionally, the control includes selectable items which allow the user to select, optionally by a single click, finger tap, or gesture, both an object variant and a sorting order of this object variant, for example whether this object variant is used for sorting the multivariate objects in an ascending sorting order or in a descending sorting order. For example, FIG. 6A is a schematic illustration of a combo box that includes selectable items, each associates a sorting order with an object variant. Another example is depicted in FIG. 6B which is another schematic illustration of an exemplary set of selectable items, virtual buttons, each associates a sorting order with an object variant. In both examples, the sorting order is represented by a sorting order icon located in proximity an object variant.

According to some embodiments, one or more object variants are selected in iterations which are set to designate object variants which are of unique importance to the user, for example object variants identified by the user before or during the method of iteratively adapting the order of multivariate objects. For example, a user may assign special importance to an object variant, a feature, of a product of a certain type. This special importance is stored in the user profile and used for future searches. This allows users to order, for instance sort, rank, and/or filter multivariate object results according to values of object variants with special importance. An instance, user specifies that he wants a bicycle and that the weight of the bicycle is impotent to him. In this case the system knows that lightweight bicycles are preferred over heavy or heavier bicycles. Optionally, a number of features are selected by the user.

In some embodiments, the object variants which are selected for a user define the first iteration(s).

As shown at 104, in each one of the iterations and after a user selection is made, an update to the order of the multivariate objects is calculated. For example, the selected object variant is added to an ordering function combining the currently selected object variant with previously added or selected object variant(s) from the plurality of object variant. For example, an ordering function: P₁̂w₁*P₂̂w₂* . . . *Pₙ̂wₙ where n denotes the number of object variants, (X₁, X₂ . . . Xₙ) denotes n weights (w₁, w₂ . . . wₙ), Pᵢ denotes a percentile of attribute Xᵢ where the sum of all weights is 1. Given a product with attribute X, the percentile of the attribute for that product is the percent of all the products in the category that has the attribute X with a smaller value than the one the current product has. Optionally, in order to represent the sorting order which is assigned to the object variants it is assumed that values are positive (X) unless marked with minus (−X). In such a manner, without loss of generally, the higher is the value the higher is its relative sorting order and when the object variant is negative − is added to the value such that the lower is the value the higher is its relative sorting order.

Optionally, each one of the object variants is associated with a weight. The ordering function takes into account the weights as factors such that different object variants which are selected for the ordering by the user may have a different effect on the order of the multivariate objects.

Optionally, personalized functions created by users so as to provide pre-defined sorting functions are defined. For example, a personalized function may be determined based on an analysis of held searches. These functions may be stored and presented for selection and/or used for ordering data in a promotional landing page or content.

According to some embodiments of the present invention, the weight of each object variant is determined by the user, for example by allowing the user to: mark the selected object variant(s) as important and/or not important, input a weight value, order the selected object variants and/or the like.

Now, as shown at 105, the updating of the GUI is instructed to present a different group of said plurality of multivariate objects according to the update and/or to reorder a currently presented group of multivariate objects according to the calculated ordering function.

As shown at 106, the process of updating the order of the multivariate objects may be iteratively repeated. In such a manner, the user can refine the order by adding and/or adapting object variants.

Optionally, a combination of object variants selected for ordering multivariate objects which comply with a search query or a product or service definition is represented as a concentrated unit in a Breadcrumbs hierarchic sequence. For example, the Breadcrumbs hierarchic sequence generated in response to an iterative process during which a user who uses the system 200 defines an order for presenting optional Smartphones with the biggest screens and the lowest weight below 400 dollars may be defined as follows: Category: Consumer Electronics->Category: Smartphones->Price: Under $400->Sort: By Screen Size (Descending) and Weight (Descending). In such embodiments, a combination of selected object variants, each associated with a sorting order indicator, is a single hierarchic level in the Breadcrumbs hierarchic sequence.

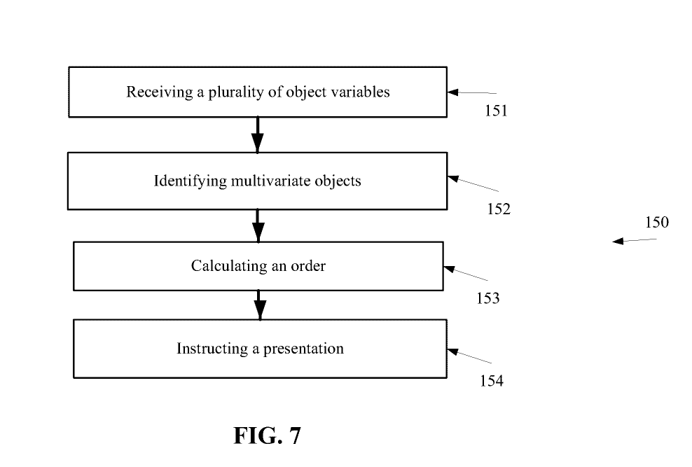

Reference is now made to FIG. 7 which is a to some embodiments of the present invention there is provides a method 150 of ordering multivariate objects having object variant values which comply with a multi term search query, according to some embodiments of the present invention, optionally with a system as defined in FIGS. 2A-B. As shown at 151, the method is based on multivariate objects. These multivariate objects may be selected from one or more databases as described below. As shown at 152, a search query is received and used to identifying complying multivariate objects. In use, as shown at 153, the search query is divided to a plurality of different object variants. This allows calculating an order to the complying multivariate objects, for example using an ordering function as defined above. As shown at 154 the complying multivariate objects in the calculated order may now be presented to the user, for example in response to the search query. For example, the search query “Cheap bestselling portable laptop” may be divided to independent variables that are added together to the ordering function, for instance the object variants “Cheap”, “Bestselling”, and “Portable” which are combined by the ordering function under the category Laptops. This ordering may occur automatically from an analysis of a search query and/pr manually upon user selection, for instance of an instruction icon. Optionally, the search query may be inputted by various means, for example from a natural language processing (NLP) engine, a text field, and a speech to text engine, and/or the like.

The methods as described above are used in the fabrication of integrated circuit chips.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and devices will be developed and the scope of the term a processor, a network, and a unit is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of iteratively adapting an order of multivariate objects, comprising:
instructing a presentation of a plurality of entries representing a plurality of multivariate objects in an order set according to at least one of a plurality of object variants on a display; and
iteratively updating said order in a plurality of iterations wherein in each one of said plurality of iterations:
identifying a user selection indicative of a new object variant from said plurality of object variants,
calculating a new order for said plurality of multivariate objects by an ordering function combining said new object variant and said at least one object variant, and
instructing an update for said presentation, wherein said update replaces said order with said new order.

2. The method of claim 1, wherein each one of said plurality of object variants is associated with a weight; wherein said ordering function takes into account respective said weight of said new object variant and of said at least one object variant.

3. The method of claim 1, wherein said user selection comprises selecting whether said new object variant is used as an ascending ordering factor or as a descending ordering factor; wherein said calculating is performed according to said selecting.

4. The method of claim 1, further comprising selecting said plurality of multivariate objects as a response to at least one of a search query and a user category selection.

5. The method of claim 1, wherein said user selection is a single click or finger tap on one of a plurality of selectable items which are presented on said display to represent said plurality of object variants.

6. The method of claim 1, wherein in each one of said plurality of iterations said user selection is made using a different control with a plurality of selectable items indicative of said plurality of object variants.

7. The method of claim 1, wherein in each one of said plurality of iterations said user selection is made using the same control with a plurality of selectable items indicative of said plurality of object variants.

8. The method of claim 1, wherein said user selection comprises selecting an object variant range for at least one of said new object variant and said at least one object variant.

9. The method of claim 1, wherein said new object variant is a quantifiable characteristic of a product or a service.

10. The method of claim 1, wherein said new object variant is quantifiable characteristic of a part of a product or a service.

11. The method of claim 1, wherein said new object variant is a suitability for a certain demographic segment or proficiency.

12. The method of claim 1, wherein said new object variant is a level of a functionality or the object of a product or a service.

13. The method of claim 1, wherein at least some of said plurality of object variants are added to a control receiving said user selection after a match a category to which said plurality of multivariate objects belongs.

14. The method of claim 1, wherein at least some of said plurality of object variants are added to a control receiving said user selection after a match with a user profile of a user making said user selection.

15. A system of iteratively adapting an order of multivariate objects, comprising:
an interface adapted to send to a browser or an application running on a client instructions to render a presentation of a plurality of entries representing a plurality of multivariate objects in an order set according to at least one of a plurality of object variants on a display; and
at least one processor;
a memory hosting a code, wherein said code is implementable by said at least one processor for iteratively calculating instructions to update said order in a plurality of iterations wherein in each one of said plurality of iterations the following code instructions are executed:
code instructions for identifying a user selection indicative of a new object variant from said plurality of object variants,
code instructions for calculating a new order for said plurality of multivariate objects by a ordering function combining said new object variant and said at least one object variant, and
code instructions for updating for said presentation by replacing said order with said new order.

16. A method of iteratively adapting an order of multivariate objects, comprising:
receiving a search query;
identifying a plurality of multivariate objects which comply with said search query;
extracting a plurality of object variants from said search query; and
calculating an order for said plurality of multivariate objects by an ordering function combining at least one ordering factor defined by at least one of said plurality of object variants with at least one other ordering factor defined by at least one other of said plurality of object variants, and
instructing a presentation of at least some of said plurality of multivariate objects in said order.
